(19) United States
(12) Patent Application Publication
(10) Pub. No.: US 2011/0066495 A1
(43) Pub. Date: Mar. 17, 2011

(54) SYSTEM AND METHOD FOR CUSTOMIZING ADS IN WEB AND MOBILE APPLICATIONS

(75) Inventors: Kalyan Ayloo, Sunnyvale, CA (US); Daniel Wong, San Jose, CA (US)

(73) Assignee: Yahoo! Inc., Sunnyvale, CA (US)

(21) Appl. No.: 12/557,869

(22) Filed: Sep. 11, 2009

(51) Int. Cl. G06Q 30/00

(52) U.S. Cl. 705/14.53; 705/14.49; 705/14.66; 705/14.73

(57) ABSTRACT

A system and method for customizing advertisements in online and mobile and applications. The system includes a software library having an application programming interface for receiving a request to create a set of ad slots to be programmatically arranged in an application. An ad server is communicatively linked to the interface and is operable to render advertisements to the application in response to an ad call requested therefrom. The advertisements are placed in predetermined ad slots for display to a user of the application.

### SUMMARY

The present application provides a system and method for customizing advertisements in web and mobile applications. The system includes a software library including an application programming interface (API) for processing requests for ad slots to be programmatically arranged in an application according to a predetermined set of instructions. The system further includes at least one ad server communicatively linked to the API and is operable to retrieve advertisements in response to an ad call. The advertisements are subsequently rendered to the application within corresponding ad slots for display to a user of the application.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a schematic view of a system for customizing advertisements in web and mobile applications;

FIG. 2 is a block diagram of the system according to one embodiment of the present invention;

FIG. 3 is a block diagram of the system according to an alternative embodiment of the present invention;

FIG. 4 is a flowchart illustrating a method for customizing advertisements in web and mobile applications;

FIGS. 5A-5C depict an example of using the present invention with an application; and

FIG. 6 is a schematic view of a computer system for implementing the methods described.

### DETAILED DESCRIPTION

With the advent of the Internet, Internet-based advertising has become increasingly popular among advertisers for promoting products and services. Advertisements may comprise banner ads, links to web pages, images, audio and/or video, animations, two- and three-dimensional objects, etc. The various advertisements used to promote products on the Internet may be displayed according to a variety of formats, such as in conjunction with a ranked result set in response to a query, embedded in a web page, a pop-up, etc.

As online advertising has progressed, there has been a growing trend in the industry to incorporate advertisements into online and mobile applications such as games and videos. For instance, an internet publisher may place banner ads somewhere on a web page containing the application (e.g., near a media player playing a video). Other approaches may include the use of pre-roll, post-roll, and mid-roll advertising that is attached to a particular application. Pre-roll advertisements are advertisements that are displayed to a user before the application begins. Unfortunately, pre-roll advertising forces the viewer to wait through a potentially unwelcome audiovisual experience. As such, an impatient viewer may simply close the application prior to it being started.

Post-roll advertisements are displayed to the user after an application is completed (e.g., at the end of a video or after a user has won a game). Post-roll advertising suffers from the fact that once the application has concluded, a user may have little or no incentive to continue watching or listening to the post-roll advertisement. In fact, some users have developed “blind spots” enabling them to simply not see post-roll advertisements.

Mid-roll advertisements are advertisements that are played in the middle of the sequential media. Timing of these mid-roll advertisements may be selected by either an algorithm or a human being. Mid-roll advertisements suffer from the fact that they may be awkward or may damage the users experience through unwanted interruption at a dramatic or informational high point. As with pre-roll advertisements, mid-roll advertisements generally take up the display area, thereby preventing the user from viewing the application. Additionally, the information the user sought from using the application may have already been provided to the user, before the mid-roll advertisement is presented thus allowing the user to terminate the application prior to the mid roll advertisement being displayed. Accordingly, seamlessly integrating advertisements within applications without adversely affecting user experience would be desirable.

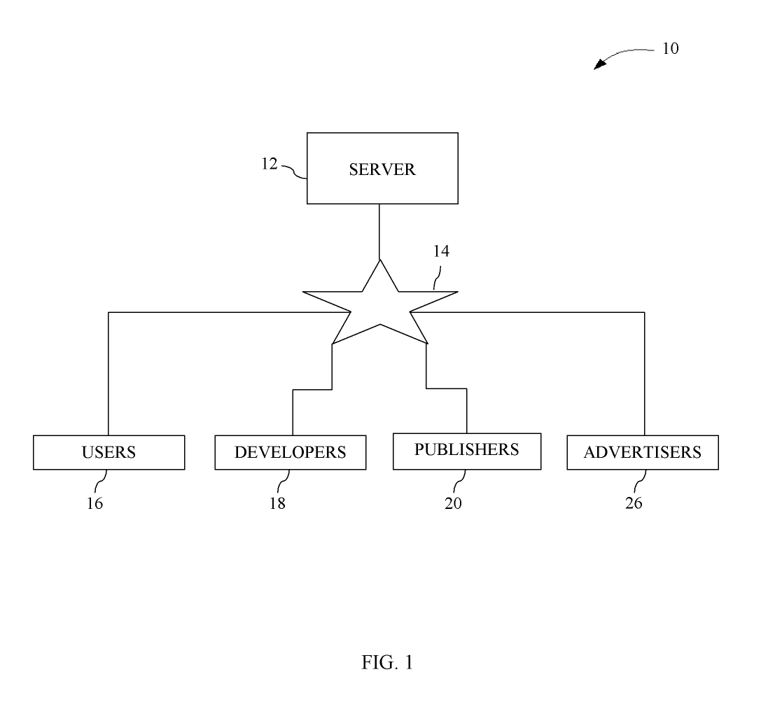

Referring now to FIG. 1, a system embodying the principles of the present application is illustrated therein and designated at 10. The system 10 comprises a server 12 capable of being in communication with a distributed network 14, which may include a connection to one or more networks such as the Internet. Other forms of a network for communication include, but are not limited to, a local and/or wide area network, a WiFi™ network, a WiMAX™ network, a mobile data network, or any other suitable network for communication. The server 12 may be a computing device, for example, operable to responsively execute requests from one or more users 16. While only one server 12 is depicted in the drawings, it should be understood to those of ordinary skill in the art that the system 10 may incorporate a plurality of servers.

The server 12 may be communicatively linked to a plurality of entities via the network 14. For purposes of discussion, such entities will be limited to those referenced herein. Nonetheless, it is to be understood that additional entities capable of accessing the network 14 may be similarly be connected to the server 12. Application developers 18 create applications for use by users 16 via various client devices. Such client devices may include laptops, home computers, personal digital assistant (PDA) devices, mobile phones, set top boxes, game consoles, portable electronic devices, etc. As used herein, the term “application” is intended in its broadest sense, and may refer to videos, interactive media such as online and mobile games, or any program having a set of executable instructions.

Applications may be pre-installed on a client device, or may be downloaded according to various techniques known to those of skill in the art. For instance, applications created by application developers 18 may be published on the Internet by publishers 20 and subsequently downloaded by users 16 via client devices. Similarly, applications may be stored by application developers 18 and/or publishers 20 in an application database 22 managed by one or more application servers 24 communicatively linked to the network 14 and configured to deploy applications to a client device. For applications intended for use with common mobile wireless communication devices such as cellular telephones and PDAs, such applications may be rendered to users 16 via mobile data networks communicatively linked to the application servers 24.

The application servers 24 may be self-controlled, controlled by separate entities, directly or indirectly incorporated with the server 12, etc. In addition, it is to be understood that the application database 22 may comprise one or more accessible memory structures such as a CD-ROM, tape, digital storage library, flash drive, floppy disk, optical disk, magnetic-optical disk, erasable programmable read-only memory (EPROM), random access memory (RAM), magnetic or optical cards, etc.

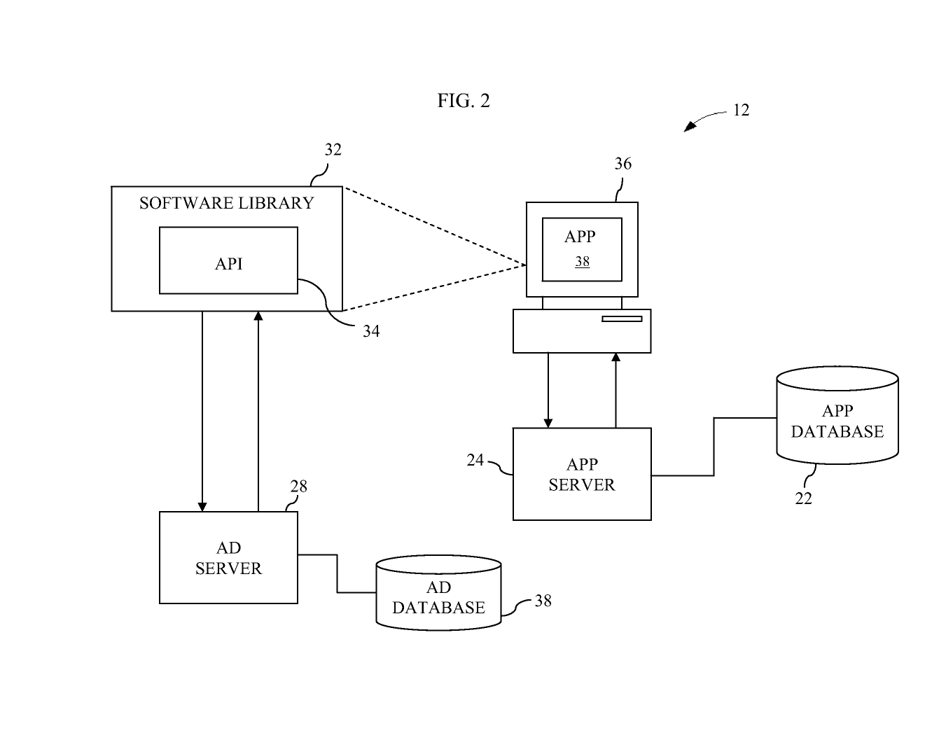

For monetization purposes, application developers 18, publishers 20, and/or advertisers 26 may integrate advertisements into applications. Thus, the server 12 is communicatively linked to at least one ad server 28 (shown in FIG. 2) operable to support multiple advertising formats, such as, but not limited to, BMP, TIFF, GIF, JPEG, and Flash formats. The ad server 28 may be a hardware and/or software module configured to search an advertisement database 30 and retrieve one or more advertisements related to applications used by users 16. The ad server 28 may be directly or indirectly incorporated with the server 12, remotely connected to the server 12 via the network 14, and/or may be controlled by a separate entity (e.g., an advertising agency). Analogous to the application database 22, the advertisement database 30 may comprise one or more accessible memory structures such as a CD-ROM, tape, digital storage library, flash drive, floppy disk, optical disk, magnetic-optical disk, erasable programmable read-only memory (EPROM), random access memory (RAM), magnetic or optical cards, etc.

Referring now to FIG. 2, a first embodiment is shown. The server 12 includes a software library 32 incorporated within a client device 36. The software library is provided with an interface such as an API 34 for receiving various requests from application programs. The API 34 is configured to communicate requests for ad slots between an application 38 running on a user's 16 client device 36 and the software library 32. By way of example, developers 18 may programmatically specify areas reserved for embedding advertisements within a given application for display to a user. Thus, an application 38 being executed on a client device 36 may be programmed to request a predetermined number of ad slots during one or more stages of the application 38. Upon receiving such a request via the API 34, the software library 32 is configured to return the requested number of ad slots (e.g., in the form of an ad object) to the application 38. Of course, as would be understood by those of ordinary skill in the art, the software library 32 may temporarily cache the ad slots in a local database (not shown).

In requesting ad slots from the software library 32, it should be understood to those of ordinary skill in the art that developers 18 may specify the location (e.g., x-y coordinates) and dimension (e.g., 120 pixels wide, 600 pixels tall) corresponding to each ad slot. Thus, developers 18 can define ad slots such that an advertisement may be embedded anywhere within an application 38 (e.g., an advertisement may be presented as a billboard on top of a building, as a sign of a vehicle, etc). Additionally, developers 18 are free to modify the manner in which a given advertisement is displayed to a user 16. For instance, a developer 18 may program an ad slot such that a corresponding advertisement will scroll across the screen of a client device 36 during a predetermined period in the application 38. As will be appreciated by those of ordinary skill in the art, developers 18 may modify numerous parameters with respect to ad slots (e.g., developers 18 may program ad slots in order to resize or change the orientation of corresponding advertisements). Accordingly, it is to be understood that the foregoing features are merely intended for purposes of illustration and should not be construed as limiting.

While developers 18 may programmatically control attributes such as, but not limited to, the position, size, and movement of a given ad slot, the software library 32 may be configured to impose certain requirements with respect to the display of ad slots. According to one aspect, the software library 32 will only return ad slots programmed to be displayed within an area of an application that is visible to a user. For instance, the software library 32 may be configured to verify that the x-y coordinates of a given ad slot are positive (or otherwise correspond to a visible area). Moreover, the software library 32 may also require that ad slots are defined at the highest layer of a stack, such that there are no overlapping layers. In this manner, other screen objects cannot block advertisements rendered in the ad slots. The foregoing restrictions are particularly beneficial in the case of cost per impression (CPM) pricing (i.e., a pricing model in which advertisers 26 agree to pay each time an advertisement is displayed), as such restrictions preclude developers 18 from fraudulently displaying an arbitrary number of “off-screen” advertisements and/or fraudulently blocking an arbitrary number of “on-screen” advertisements.

Once the requested number of ad slots are created for a given application 38, the application 38 may be configured to communicate a series of ad calls (e.g., by way of programming function such as “get ad”) to the software library 32 via the API 34. As used herein, the term “ad call” refers to a request an advertisement to be rendered in an appropriate ad slot (i.e., as programmatically specified by the developer). Of course, it should be understood that an ad call may include a request for a plurality of advertisements to be placed in a set of corresponding ad slots, or a request for merely one advertisement to be placed in a corresponding ad slot. In addition, a developer 18 may program an application to submit a single ad call requesting advertisements for all ad slots during initialization of the application. Alternatively, a developer 18 may program an application to submit a series of ad calls throughout execution of the application.

As part of an ad call, it should be understood that developers 18 may request advertisements satisfying certain requirements. For instance, developers 18 may request advertisements having specific dimensions. Additionally, developers 18 may request advertisements based on specific pricing models, e.g., cost per click (CPC) pricing, cost per action (CPA) pricing, cost per impression (CPM) pricing, etc. Of course, the foregoing examples are merely intended for purposes of illustration, as those of ordinary skill in the art will appreciate that developers 18 may modify various characteristics of a given advertisement.

As shown in FIG. 2, the software library 32 is communicatively linked to the ad server 28 via the API 34. Upon receiving an ad call, the software library 32 prompts the ad server 28 for an advertisement. Hence, it can be seen that the application 38 may be programmatically configured to make native calls to the software library 32, and the software library 32 is operable to make network calls (e.g., HTTP, TCP/IP, etc.) to the ad server 28. In turn, the ad server 28 analyzes the advertisement database 30 and retrieves an appropriate advertisement, which is subsequently rendered in an ad slot specified by the developer 18. Of course, it should be understood to those of ordinary skill in the art that the software library 32 may temporarily cache the ad slots in a local database (or the like), which may or may not be the same database used to store the ad slots. As will be explained in greater detail below, the ad server 28 may select advertisements based on a variety of factors (e.g., time, demographics, category, content, etc). Additionally, it is to be understood that the ad server 28 may select advertisements using various algorithms and techniques known to those of ordinary skill in the art.

While developers may not control which advertisements will be displayed to users, developers can programmatically dictate when an advertisement will be displayed to a user, where the advertisement will be displayed on the screen of a client device, what type (e.g., CPM, CPC, CPA, etc.) of advertisement will be displayed to the user, and how the advertisement will be displayed to the user (e.g., it may scroll, tilt, be automatically replaced by another advertisement after a predetermined period of time, be resized, etc.). By way of example, a developer 18 may decide to display a CPM advertisement when a user 16 first loads an application 38, such as an action video game. The developer 18 may decide to display a CPC advertisement (e.g., “Action Games at Best Buy”) upon completion of a certain level. Additionally, if the user 16 earns a new “High Score” in the game or reaches a certain stage where a conversion is imminent, the developer may program the application 38 to display a CPA advertisement prompting the user 16 to fill out a form or survey to win prizes on a certain website. Accordingly, developers 18 are provided with a great deal of freedom in customizing the overall presentation of a given application.

According to one embodiment, the application 38 may be programmed to communicate metadata regarding the behavior and profile of the user 16 in conjunction with submitting an ad call to the software library 32. For instance, information such as metadata regarding the user's 16 behavior and profile may be gleaned by tracking user interaction with the client device 36 and/or by collecting information stored within the client device 36. The software library 32 is configured to communicate such information to the ad server 28. In turn, the ad server 28 may utilize this information to select advertisements uniquely tailored to the user 16. By way of example, the ad server 28 may select a given advertisement based on the user's 16 age, location, gender, etc. Moreover, the selected advertisement may also be based on a corresponding expected revenue (e.g., expected revenue for a given advertisement may be calculated according to a historical click-through rate associated with the advertisement).

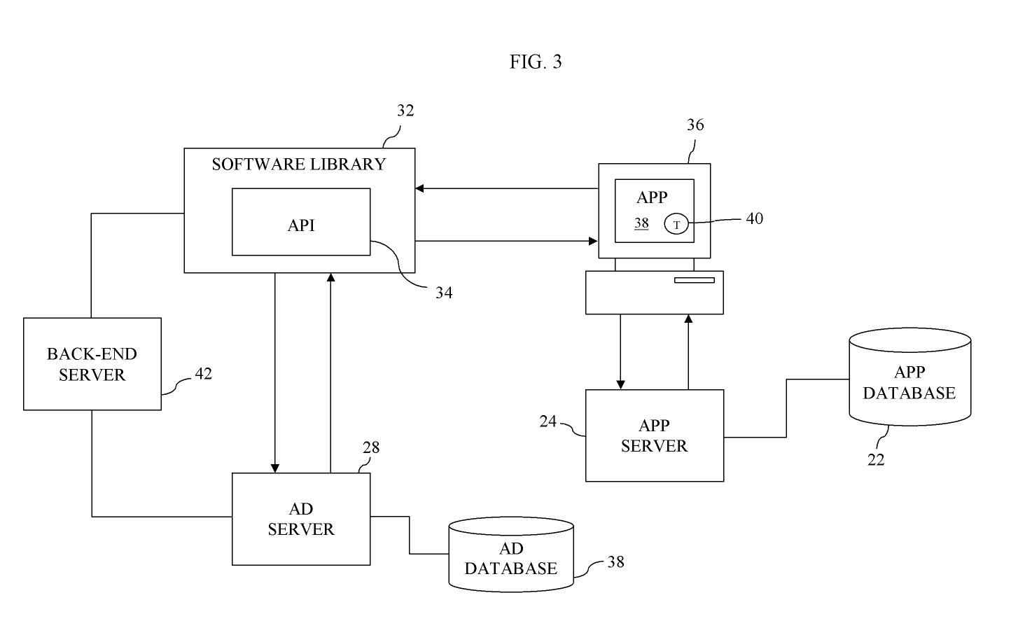

According to an alternative embodiment, the software library 32 is remotely connected to the client device 36 via the network 14, as shown in FIG. 3. For instance, the software library 32 may be implemented on a separate client device, managed by a separate entity and/or provided as a web service or other client/server protocols, etc. As such, the application 38 may make network calls (e.g., HTTP, TCP/IP, etc.) to the remote software library 32, and the software library 32 may be configured to return information to the application 38 over protocols (e.g., HTTP, TCP/IP). Of course, the software library 32 is also operable to make network calls to the ad server 28. In this embodiment, information such as metadata regarding the user's 16 behavior and profile is processed by at least one back-end server 42 and subsequently communicated to the ad server 28. The back-end server 42 may be integrated with the server 12 as a single unit, or may be communicatively linked to the ad server 32 and a front-end server such as the API 34, as shown in FIG. 3.

Moreover, a tracking object 40 may be embedded in the application 38 to track the user's 16 interactions with the client device 36. For instance, the tracking object 40 may include a component such as an applet program written in an interpretive language such as Java™. Alternatively, the tracking object 40 may include a program written in scripting language such as JavaScript™ to track and gather user activity. Moreover, a Java applet and a JavaScript code embedded in a web page may collectively be used to gather user data.

The back-end server 42 is operable to receive data indicative of user interactions from the tracking object 40 and transmit the data to the ad server 28. As previously mentioned, the ad server 28 may utilize such information to select an advertisement to be displayed to the user 16. For instance, if the tracking object 40 detects that the user 16 has clicked on or scrolled over a certain item within the application 38, the back-end server 42 may communicate information indicative of such user activity to the ad server 28. In turn, the ad server 28 may select an advertisement related to the item in question.

By way of example, if the application 38 corresponds to a car racing game being played by the user 16, and the tracking object 40 detects that the user 16 has clicked on a tire of a car, the ad server 28 may return an advertisement related to Belle Tire, Inc. By monitoring user interactions, the present invention may dynamically render contextually sensitive advertisements, thereby yielding an increase in expected revenues.

Furthermore, although a tracking object 40 is not shown in FIG. 2, it is to be understood that a tracking object 40 similarly may be provided. Nonetheless, since the embodiment depicted in FIG. 2 provides a software library 32 residing within a client device 36, the software library 32 may be configured to track user interactions using alternative known techniques. Accordingly, those of ordinary skill in the art will appreciate that the techniques discussed above with reference to the embodiment depicted in FIG. 3 are similarly applicable to the embodiment depicted in FIG. 2.

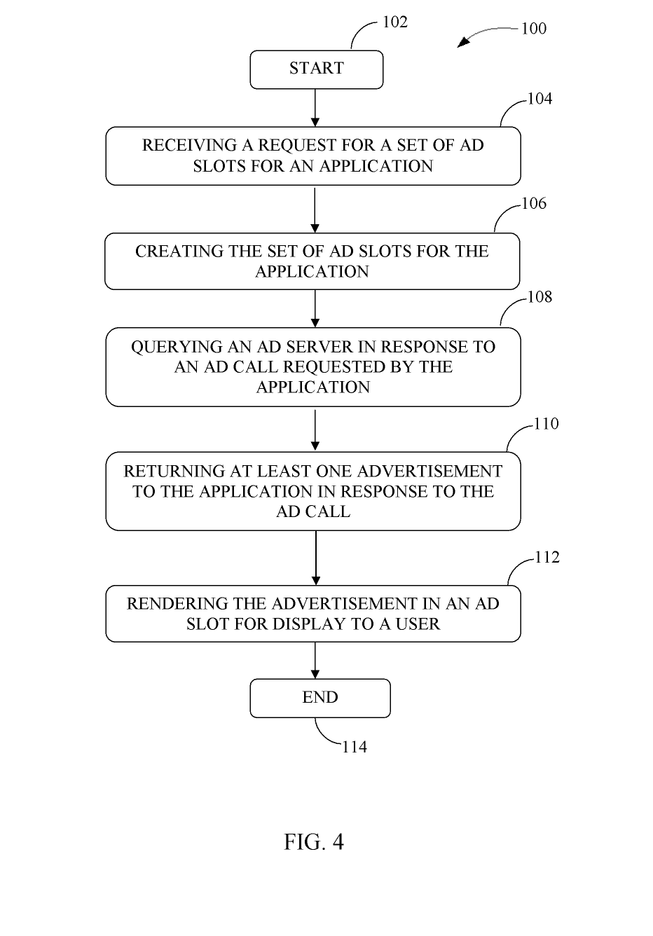

Referring now to FIG. 4, a method 100 for automatically customizing advertisements in online and mobile applications starts in block 102. At block 104, a request is received from an application for a set of ad slots. The request may be communicated via an interface such as the application programming interface API 34. At block 106, the requested number of ad slots are created and embedded within the application. The ad slots are arranged within the application according to programming instructions specified by its developer 18.

Continuing with block 108, the ad server 28 is queried in response to an ad call requested from the application. In response, the ad server 28 returns at least one advertisement to the application, as indicated by block 110. It is to be understood that the ad server 28 may select the advertisement according to any of the techniques described above. At block 112, the advertisement is rendered in an appropriate ad slot for display to a user of the application. The method ends at block 118.

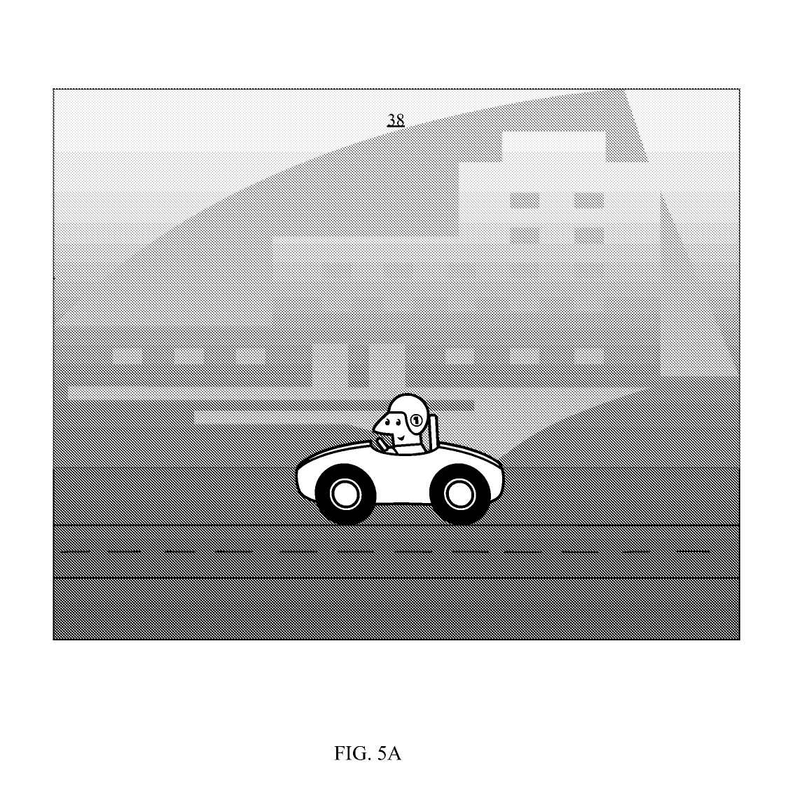

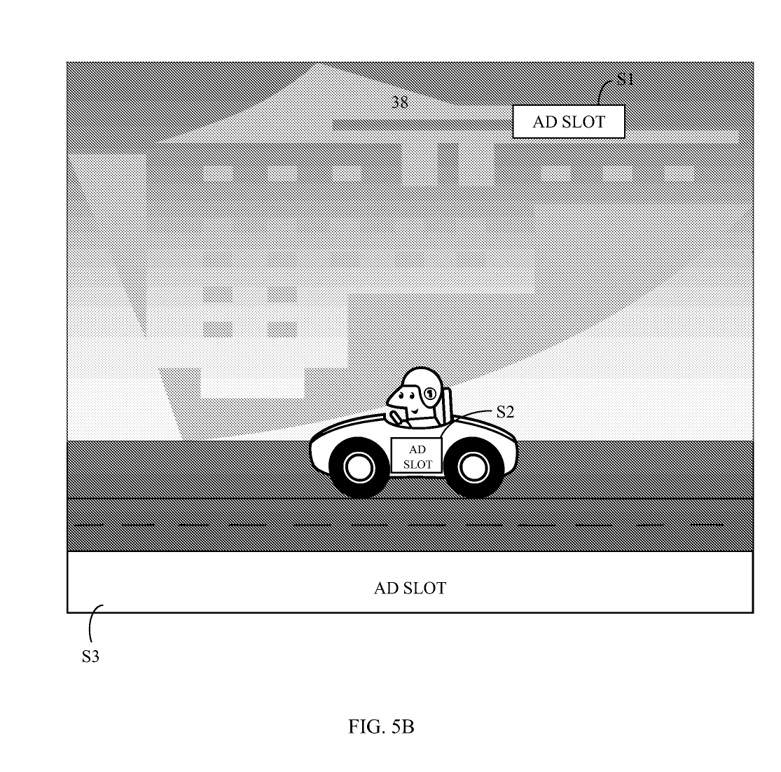

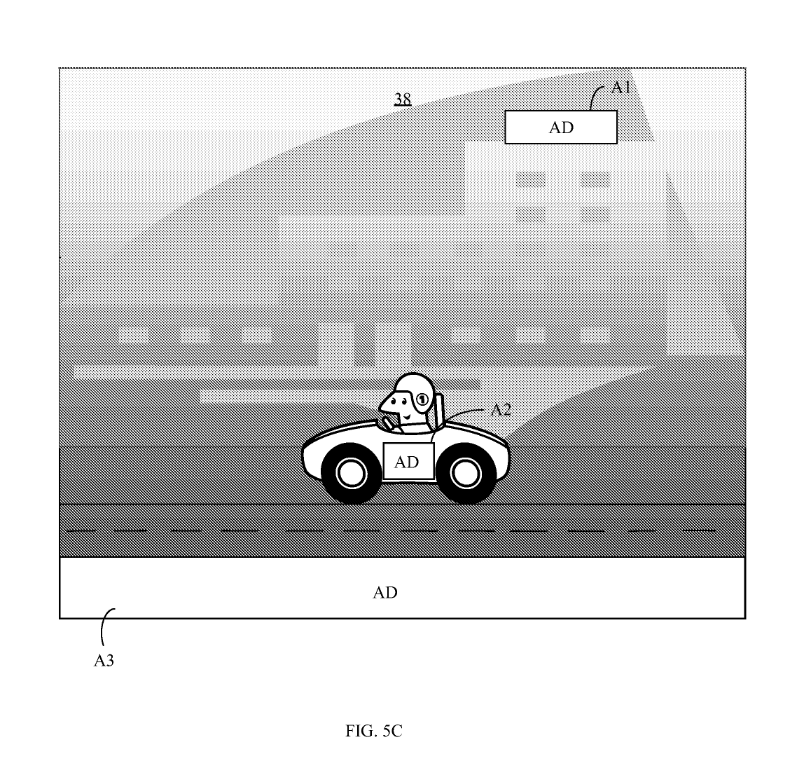

Referring now to FIGS. 5A-5C, an example using the system and methods of the present invention is shown. In FIG. 5A, an application 38 directed to a car racing game is shown on a screen of a user's client device 36 (e.g., a portable computer, cell phone, PDA, etc.). As can be seen, the depicted screen shot does not include any advertisements being displayed to the user. Using the techniques of the present invention however, a plurality of advertisements (e.g., product placement ads) may be embedded into the application 38. For instance, a developer 18 may programmatically specify areas within the application 38 for displaying advertisements. During runtime of the application 38, a software library 32 such as that discussed above may be prompted to create a set of ad slots S1, S2, and S3, as shown in FIG. 5B. Of course, it should be understood to those of ordinary in the art that more or less ad slots may be provided, and the ad slots S1, S2, S3 depicted in FIG. 5B may be arranged according to any manner desired.

As can be in seen FIG. 5C, a developer 38 may program the application 38 to display a first ad A1 on the top of a building in the background, a second ad A2 on a racecar (e.g., as a sponsor), and a third ad A3 such as, but not limited to, a banner ad at the bottom of the screen. Accordingly, the present invention provides a system and method for seamlessly embedding advertisements into an application without adversely affecting the application or a user's experience.

Of course, it should be understood to those of ordinary skill in the art that different advertisements may be embedded into a given application every time the application is executed. In this manner, advertisements may continuously be rendered based on a given user's user profile and/or behavior. For example, since a user's profile may be updated over time, advertisements may be selected in view of any such updates. In addition, a user may click on one object within the application during one session, yet click on an entirely unrelated object during a separate session. As such, advertisements may be displayed to the user based at least in part on the object clicked in the former session, whereas advertisements may be displayed to the user based at least in part on the object clicked during the latter session. Accordingly, advertisements may be tailored more directly to a given user's current interests.

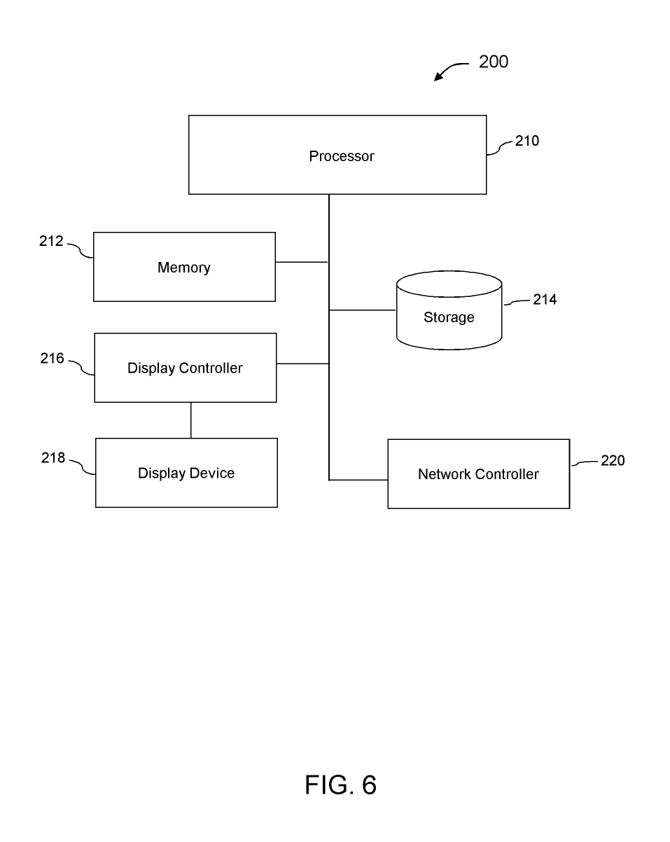

Any of the modules, servers, or engines described may be implemented in one or more computer systems. One exemplary system is provided in FIG. 6. The computer system 200 includes a processor 210 for executing instructions such as those described in the methods discussed above. The instructions may be stored in a computer readable medium such as memory 212 or storage devices 214, for example a disk drive, CD, or DVD. The computer may include a display controller 216 responsive to instructions to generate a textual or graphical display on a display device 218, for example a computer monitor. In addition, the processor 210 may communicate with a network controller 220 to communicate data or instructions to other systems, for example other general computer systems. The network controller 220 may communicate over Ethernet or other known protocols to distribute processing or provide remote access to information over a variety of network topologies, including local area networks, wide area networks, the Internet, or other commonly used network topologies.

In another embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Further the methods described herein may be embodied in a computer-readable medium. The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

As a person skilled in the art will readily appreciate, the above description is meant as an illustration of the principles of this application. This description is not intended to limit the scope or application of this application in that the system 10 is susceptible to modification, variation and change, without departing from spirit of this application, as defined in the following claims.

We claim:

1. A system for customizing advertisements in online and mobile applications, the system comprising:
a software library including an interface for receiving a request to create a set of ad slots to be programmatically arranged in an application according to a first predetermined set of instructions, the software library being configured to responsively generate the set of ad slots within the application;
wherein the interface is communicatively linked to at least one ad server, the ad server being configured to return at least one advertisement to the interface in response to an ad call requested from the application via the interface; and
wherein the at least one advertisement is rendered in at least one ad slot for display to a user of the application, the at least one ad slot being selected from the set of ad slots.

2. The system of claim 1, wherein the set of ad slots only includes ad slots oriented such that advertisements placed therein will be unblocked or in a visible area when displayed to the user.

3. The system of claim 1, wherein the at least one advertisement corresponds to at least one of a specific size or type, the size or type being specified in the ad call.

4. The system of claim 1, wherein the at least one advertisement is embedded into the application according to a second predetermined set of instructions, the second predetermined set of instructions being specified in the ad call.

5. The system of claim 1, wherein the ad call includes at least one of metadata associated with the user, or information indicative of a user event.

6. The system of claim 5, wherein the ad server applies an algorithm to select the at least one advertisement, the algorithm being based on a set of inputs selected from a group consisting of: the metadata, the information indicative of the user event, a historical click through rate associated with the at least one advertisement, a category associated with the at least one advertisement, and content associated with the at least one advertisement.

7. The system of claim 6, further comprising at least one back-end server in communication with the interface and operable to receive the ad call, the back-end server being communicatively linked to the ad server and operable to transmit the ad call thereto.

8. A method for customizing advertisements in online and mobile applications, the method comprising:
receiving a request for a set of ad slots for an application, the request being received by way of an interface;
creating the set of ad slots for the application, the set of ad slots being programmatically arranged in the application according to a first predetermined set of instructions;
querying at least one ad server in response to an ad call requested by the application, the ad call being requested via the interface;
returning at least one advertisement to the interface in response to the ad call; and
rendering the at least one advertisement in at least one ad slot of the set of slots for display to a user of the application.

9. The method of claim 8, wherein the set of ad slots only includes ad slots oriented such that advertisements placed therein will be unblocked or in a visible area when displayed to the user.

10. The method of claim 8, wherein the at least one advertisement corresponds to at least one of a specific size or type, the size or type being specified in the ad call.

11. The method of claim 8, wherein the at least one advertisement is embedded into the application according to a second predetermined set of instructions, the second predetermined set of instructions being specified in the ad call.

12. The method of claim 8, further comprising receiving at least one of metadata associated with the user, or information indicative of a user event, the at least one of the metadata and the indicative information being received with the ad call via the interface.

13. The method of claim 12, further comprising applying an algorithm to select the at least one advertisement, the algorithm being based on a set of inputs selected from a group consisting of: the metadata, the information indicative of the user event, a historical click through rate associated with the at least one advertisement, a category associated with the at least one advertisement, and content associated with the at least one advertisement.

14. The method of claim 13, further comprising communicating the ad call to at least one back-end server in communication with the interface, the back-end server being communicatively linked to the ad server and operable to transmit the ad call thereto.

15. In a computer readable storage medium having stored therein instructions executable by a programmed processor for customizing advertisements in online and mobile applications, the storage medium comprising instructions for:
receiving a request for a set of ad slots for an application, the request being received by way of an interface;
creating the set of ad slots for the application, the set of ad slots being programmatically arranged in the application according to a first predetermined set of instructions;
querying at least one ad server in response to an ad call requested by the application, the ad call being requested via the interface;
returning at least one advertisement to the interface in response to the ad call; and
rendering the at least one advertisement in at least one ad slot of the set of slots for display to a user of the application.

16. The computer readable storage medium of claim 15, wherein the set of ad slots only includes ad slots oriented such that advertisements placed therein will be unblocked or in a visible area when displayed to the user.

17. The computer readable storage medium of claim 15, wherein the at least one advertisement corresponds to at least one of a specific size or type, the size or type being specified in the ad call.

18. The computer readable storage medium of claim 15, wherein the at least one advertisement is embedded into the application according to a second predetermined set of instructions, the second predetermined set of instructions being specified in the ad call.

19. The computer readable storage medium of claim 15, further comprising receiving at least one of metadata associated with the user, or information indicative of a user event, the at least one of the metadata and the indicative information being received with the ad call via the interface.

20. The computer readable storage medium of claim 19, further comprising applying an algorithm to select the at least one advertisement, the algorithm being based on a set of inputs selected from a group consisting of: the metadata, the information indicative of the user event, a historical click through rate associated with the at least one advertisement, a category associated with the at least one advertisement, and content associated with the at least one advertisement.

21. The computer readable storage medium of claim 20, further comprising communicating the ad call to at least one back-end server in communication with the interface, the back-end server being communicatively linked to the ad server and operable to transmit the ad call thereto.
